(19) United States
(12) Patent Application Publication
(10) Pub. No.: US 2007/0292131 A1
(43) Pub. Date: Dec. 20, 2007

(54) METHODES AND PROCESSES OF ALL-OPTICAL SWITCHING OF OPTICAL DATA PACKETS

(76) Inventors: Volodymyr Slobodyanyuk, San Diego, CA (US); Zufar Biglov, Moscow (RU)

Correspondence Address: SLOBODYANYUK VOLODYMYR, P.O. BOX 928326, SAN DIEGO, CA, 92192-8326, US

(21) Appl. No.: 11/424,343

(22) Filed: Jun. 15, 2006

(51) Int. Cl. H04J 14/00

(52) U.S. Cl. 398/51

(57) ABSTRACT

A self-routing switching methods that allows to direct optical packet based on the information of the packet header.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to the methods of routing of optical data packets, specifically to such methods which are used to route optical data packets based on the routing information in the packet header.

### BACKGROUND OF THE INVENTION

In modern telecommunications connections with highest capacity and bandwidth are provided by means of fiber-optic networks.

To ensure that all packets are forwarded correctly to destination, network switches and routers are placed in the network nodes.

Currently, telecommunications industry is pursuing several possible evolution paths regarding implementing optical switching, most notably optical-electronic and all-optical switching.

Many are considering that further progress in development of intelligent Optical-Electronic-Optical (O-E-O) switches will be able to adequately satisfy their current and future needs.

Others are thinking about optical switches without electronic components, all optical (O-O-O) switches.

The conversion of high data rate optical signals into the electrical domain and the processing of such signals provides difficulties and may limit the data handling rates within optical networks.

The main reason is inefficient nature of conversion of optical packets into electrical packets. Additionally, due to the limited distance that high-frequency electrical signals can travel without significant losses, the size of the electrical switches and routers is also limited.

Ability to avoid conversion of optical packets into electrical packets for the purposes of routing and switching, and perform switching of the optical pulses in an all-optical switching fabric will allow creating communications networks that can process traffic at much higher rate without limitations of the electrical switches and routers, thus improving scalability, flexibility, and dynamic delivery of communication services.

All-optical switches allow to converge functions of transport and high-bandwidth cross-connects.

Multiple methods and processes were proposed to be used so that optical signals could be switched without converting them into electronic signals.

At this time, 3-Dimensional micromechanical systems (3D MEMS) are considered to be most promising technology to deliver all-optical switching solution which is realized by providing an optical cross connect utilizing an array of tilting micro-electromechanical systems (MEMS) mirrors for directing optical signals from input optic fibers to output optic fibers.

Other technologies were also considered for implementation of the all-optical switching solution: liquid crystal technology; thermo-optic bubble; thermo-optic/electro-optic waveguide, and other exotic technologies (such as based on quantum properties of rubidium vapor, resonant rings etc)

Nevertheless, all these technologies suffer from number of disadvantages:
(a) These solutions do not provide dynamic routing of individual packets.
(b) Technical complexity to implement these devices is outstanding.
(c) Requirement to separate the flow of control data responsible for routing, and payload data adds complexity onto the network architecture.
(d) In some case, control data for switching and routing has to be delivered in non-optical format.

### BACKGROUND OF INVENTION-OBJECTS AND ADVANTAGES

Several objects and advantages of the present invention are:
(a) to provide methods of all-optical switching that will route optical packet based on the information in the packets header;
(b) to provide methods of all-optical switching that will dynamically route individual optical packets, independently of the routing direction of the previous and future packets;
(c) to provide a methods of all-optical switching that will independently and simultaneously route optical packets coming from multiple sources;

### SUMMARY

In accordance with present invention methods of all-optical switching are based on the capability of the optical radiation to modify electromagnetic properties of the medium, so that propagation of the optical packet through this medium is influenced by the structure, intensity, and duration of the header of the optical packet.

### DRAWING—FIGURES

FIG. 1 shows an exemplary structure of the optical packet.

FIG. 2 shows an exemplary structure of the optical pulse where header's intensity is used for coding.

FIG. 3 shows an exemplary block diagram of the routing of the optical pulse based on the headers intensity.

FIG. 4 shows an exemplary structure of the optical pulse where header's duration is used for coding.

FIG. 5 shows an exemplary block diagram of the the process of using delay line to control time interval between arrival of delayed packets.

FIG. 6 shows an exemplary structure of the optical pulse where header's structure is used for coding.

FIG. 7 shows an exemplary block diagram of the process of generating delayed packet from the original packet using delay line.

FIG. 8 shows an exemplary block diagram of the process of generating signal at the second harmonic.

FIG. 9 shows an exemplary block diagram of the method of routing optical packet using process of creating of the plasma mirror.

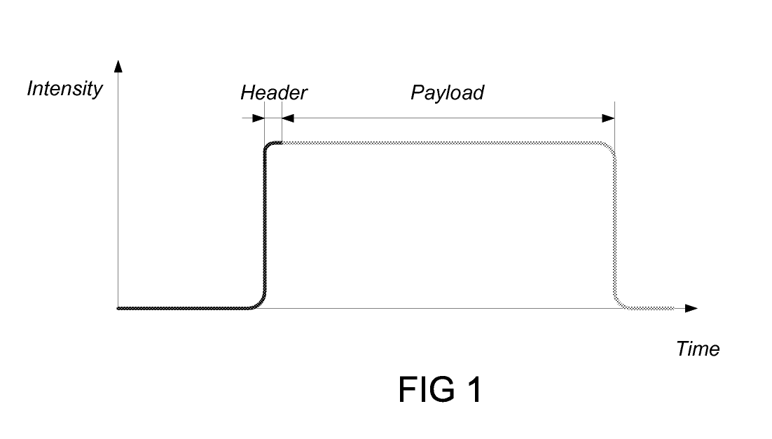

DETAILED DESCRIPTION—in the most general terms, optical packet consists of two parts—header of the packet, and payload of the packet, as illustrated in FIG. 1. It is the header of the packet that contains information specific to the path that this packet should traverse in order to reach its destination.

Present invention allows to perform switching of the optical packet based on header's
intensity,
duration,
Structure of the header of the optical packet.

Three physical phenomena may be used by present invention to achieve the stated goal of all-optical switching:
Generation of the Electronic Density Wave
Non-Linear Conversion of the Original Frequency of Optical Pulse
Plasma Mirror Generation

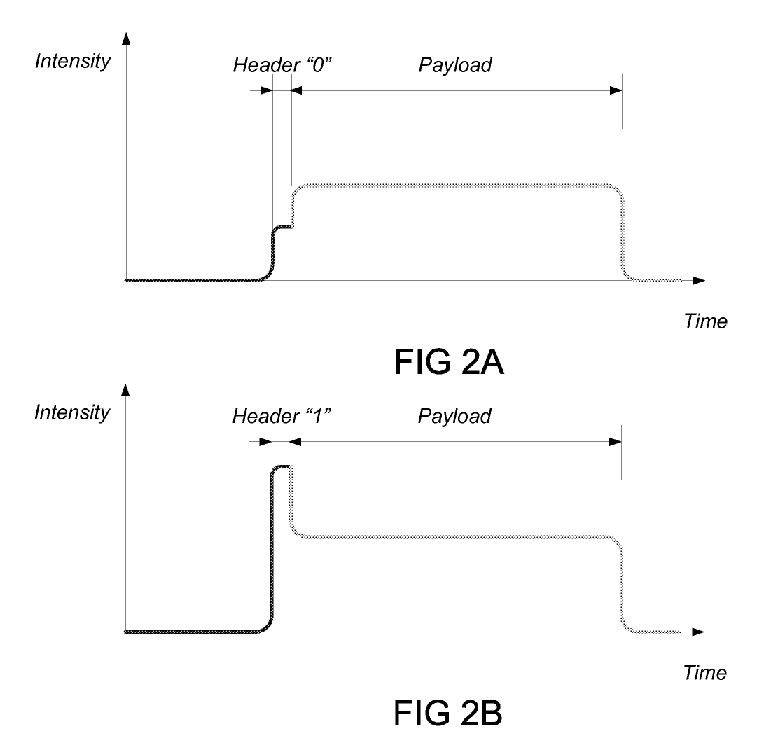

For the optical switching, that is based on the intensity of the header, routing is achieved by means of creating of the electronic density wave (EDW). For simplicity, let's imagine that the header's intensity could be set to values “1” or “0” only, as illustrated in FIG. 2A and FIG. 2B.

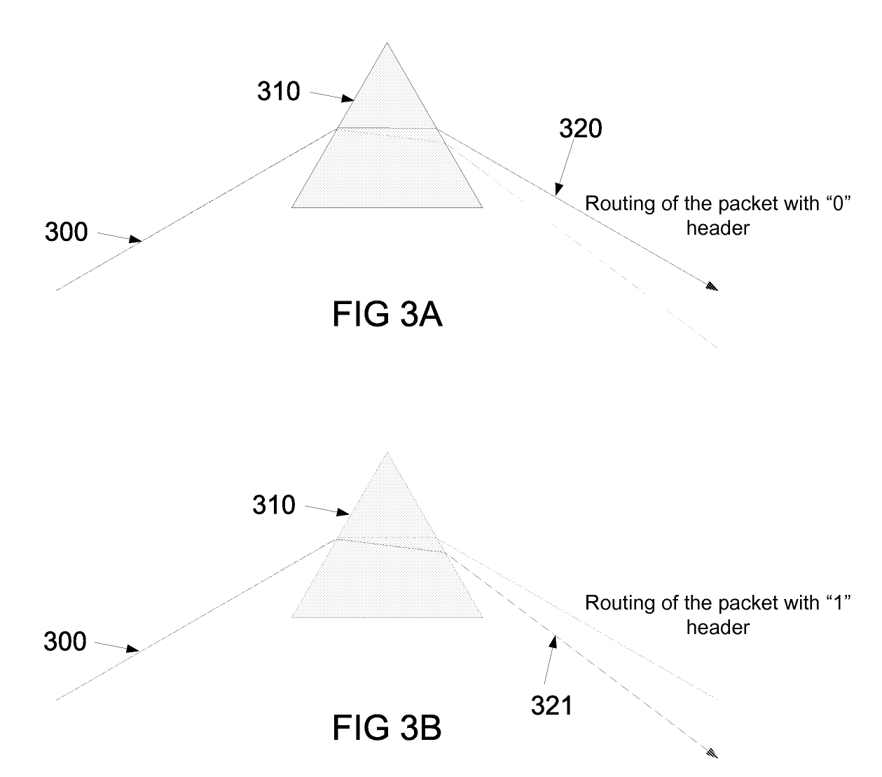

Spatial separation of the packets, as shown on the FIG. 3A and FIG. 3B, is based on the intensity of the header. This separation is achieved when optical packet 300 is traveling through refractive device, such as prism 310, with refractive index, sensitive to the intensity of the pulse.

Such sensitivity could be a product of the generation of the EDW in the refractive media. When high intensity header (set to value “1”) enters the prism, it will rapidly “pull” electrons from the valence band of the crystal, and will create EDW along its propagation paths. Refractive index of the prism will be affected by the thickness of the EDW.

The process of creation of EDW may be highly nonlinear, and non-linearly dependent on the intensity of radiation. Logical levels of “0” and “1”, and the intensity of the payload packets should be selected in such a way, that distinguishable changes in the density of the EDW are created by the header of the optical packet.

Once created, EDW will start gradual decay at a speed that depends on the specific properties of the medium, thus allowing specific time window for the optical packet to experience the influence of modified refraction index. In this fashion, optical packet as a whole will be routed based on the content of the header (320 or 321).

In order to implement more sophisticated switching process, header's intensity should have various levels of intensity, so that each level corresponds to the specific route.

For the optical switching, that is based on the duration of the header, routing of the optical packet is based on the results of the properties of the autocorrelation function of the packet's header. Optical header should be shaped in such a way that its autocorrelation function should have significant non-zero value at certain delay when header is set to value “1”, and have a zero value when header is set to “0”. In present invention, value of the autocorrelation function is measured when packet is mixed with the same packet that was delayed (through some sort of Delay Line) for defined period of time.

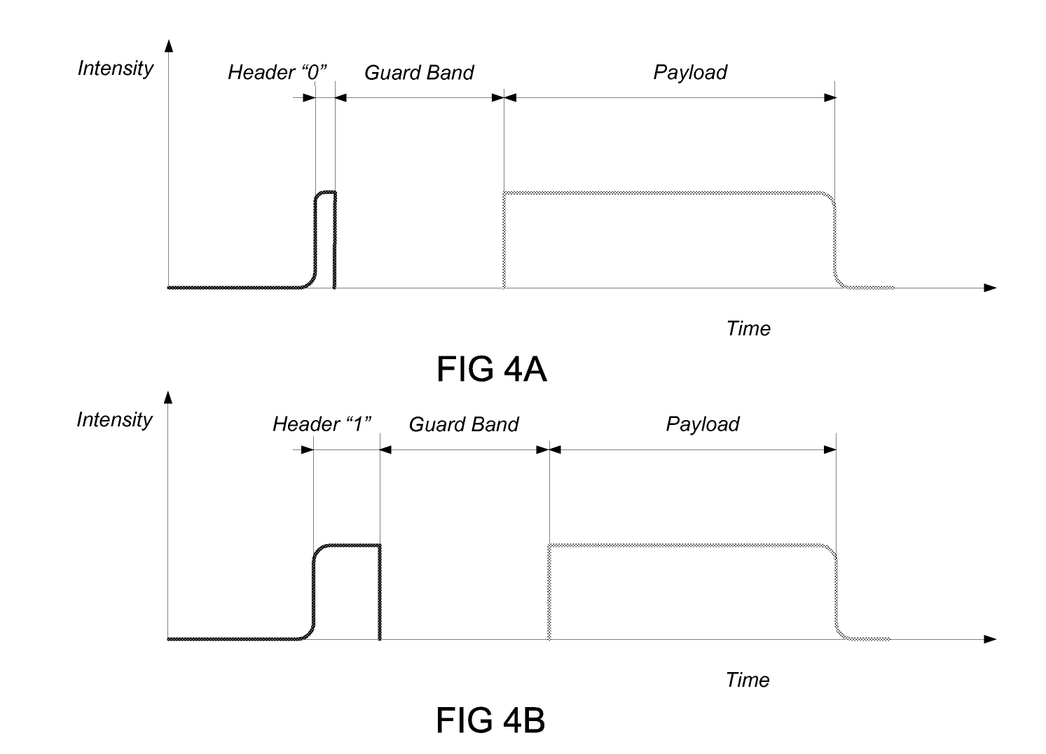

For simplicity, let's imagine that the header's duration could be set to values “1” or “0” only, as illustrated in FIG. 4A and FIG. 4B.

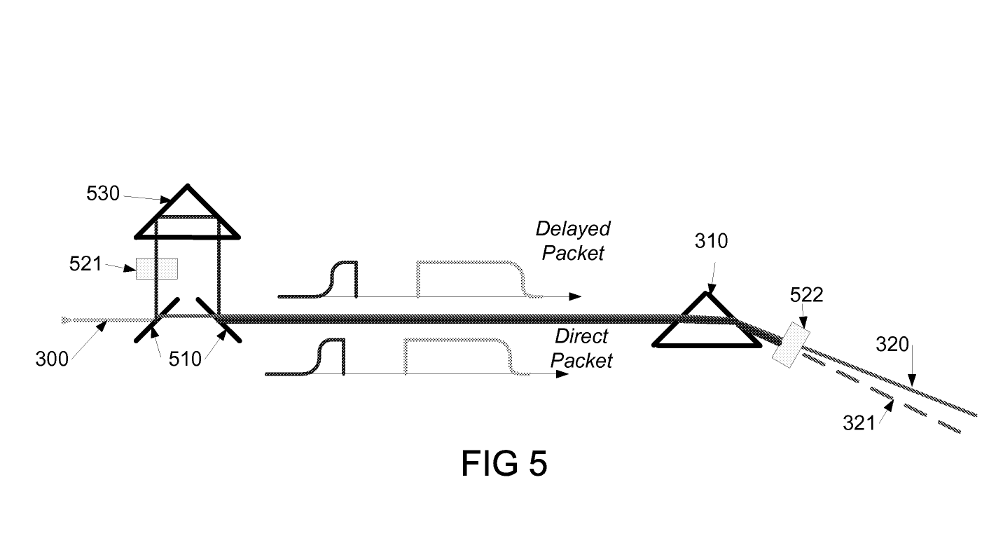

Duration of “0”, “1” headers 300 and propagation delay caused by the Delay Line 510 and 530 are chosen in such a way, that only header of duration “1” can overlap with its own delayed copy, as shown in FIG. 5. Header of duration “0”, as well as the train of pulses in the payload section of the optical packet shall not overlap (this requirement may result in certain requirements towards duration and spacing of the header and payload of optical packet).

Spatial switching occurs when both packets propagate through the prism 310, as density of the EDW, and respectively refraction angle depends on whether direct and delayed headers overlapped or not (they will overlap when the header value is set to “1”). If the headers do overlap, then they will create EDW, and the propagation path for the optical packet will be different compared to the situation when headers do not overlap (as the density of EDW will be significantly lower due to the non-linear nature of EDW generation).

In order to be able to avoid interference between straight and delayed copies of the optical packet, some sort of the packet selector 521, 522 can be used. In its most traditional form, this selector could be based on the fact that it is possible to have straight and delayed packets to have orthogonal polarization (what could be achieved through polarization rotation in 521), so that selector 522 will allow only one type of polarization to go through, while cutting the other polarization. In the proposed invention, only original optical pulse will continue to travel through optical network, delayed pulse will be filtered out (using previously described selector).

For the optical switching, that is based on the structure of the optical packet, routing of the optical packet is based on the properties of the autocorrelation function of the packet's header. Optical header should be shaped in such a way that its autocorrelation function should have significant non-zero value at certain delay when header is set to value “1”, and have a zero value when header is set to “0”. In many respects this method is similar to previously described method where routing is based on the header's duration. However, the difference is that in this method both shape and duration of the packet contribute to the structure of the autocorrelation function so that it exhibit sharp local maximum at specific delay values, thus allowing more robust separation of optical packets. In present invention, value of the autocorrelation function is measured when packet is mixed with the same packet that was delayed (through some sort of Delay Line) for defined period of time.

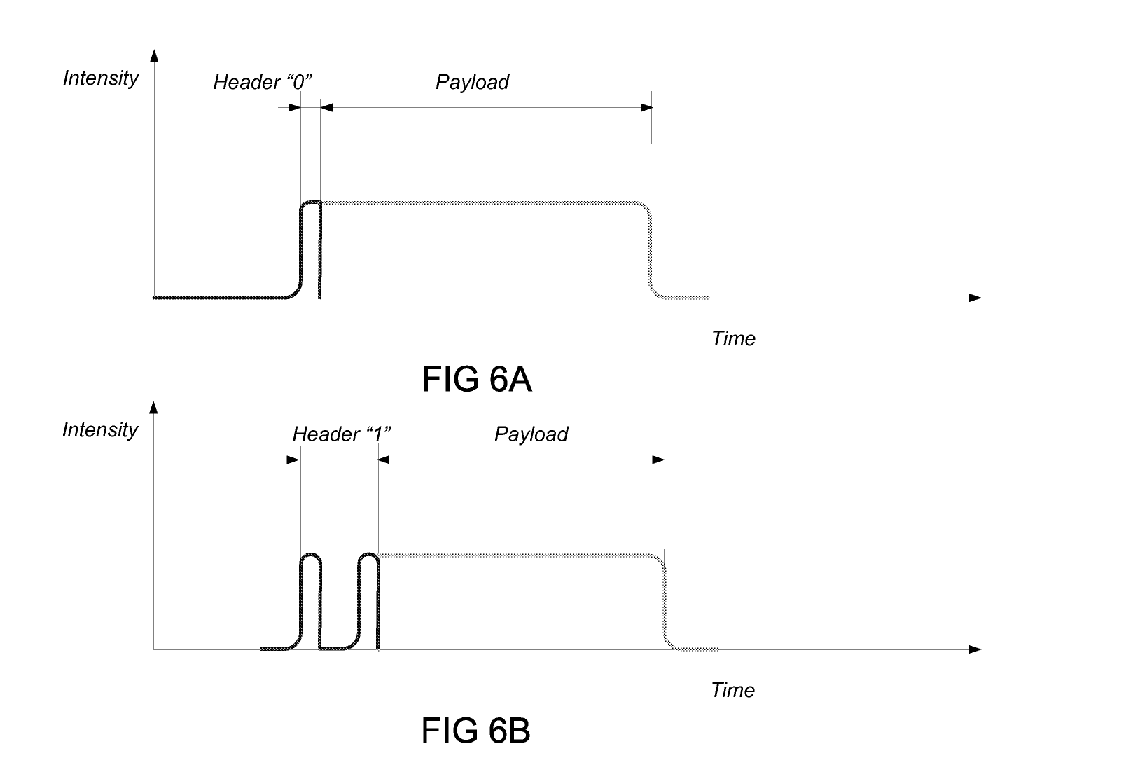

For simplicity, let's imagine that the header's duration could be set to values “1” or “0” only, as illustrated in FIG. 6A and FIG. 6B.

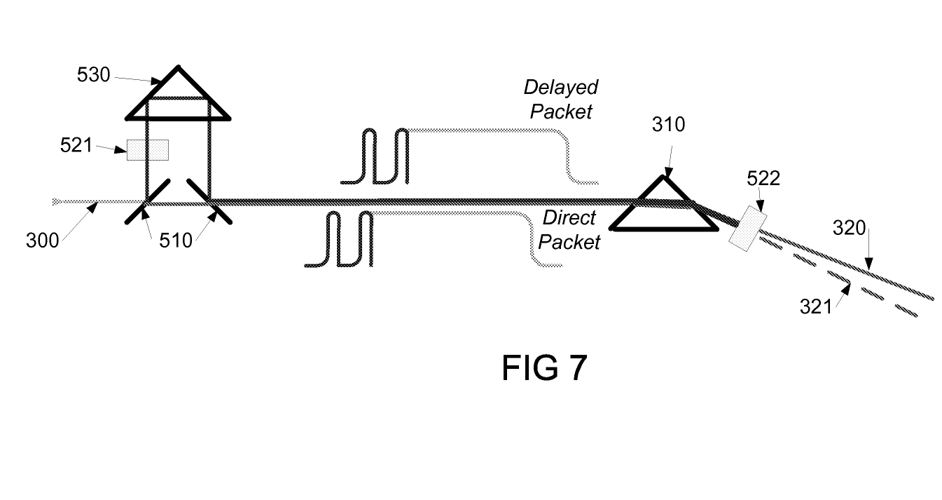

Temporal spacing between pulses 300 comprising “0”, “1” headers and propagation delay caused by the Delay Line 510, 530 are chosen in such a way, that only pulses of header carrying information “1” can overlap, as shown in FIG. 7. Header of duration “0”, as well as the train of pulses in the payload section of the optical packet shall not overlap (this requirement may result in additional requirements to the how structure of the header and payload sections of the optical).

Spatial switching occurs when both packet propagate through the prism, as refraction angle depends on whether direct and delayed headers overlapped or not (they will overlap when the header value is set to “1”). If the header pulses do overlap, then they will create EDW, and the propagation path for the optical packet will be different compared to the situation when headers do not overlap (as the density of EDW will be significantly lower due to the non-linear nature of EDW generation).

As in the previous example, in order to be able to avoid interference between straight and delayed copies of the optical packet, some sort of the packet selector 521, 522 can be used. In its most traditional form, this selector could be based on the fact that it is possible to have straight and delayed packets to have orthogonal polarization (what could be achieved through polarization rotation in 521), so that selector 522 will allow only one type of polarization to go through, while cutting the other polarization. In the proposed invention, only original optical pulse will continue to travel through optical network, delayed pulse will be filtered out (using previously described selector).

Method of all-optical switching could be implemented by using EDW created by radiation that was generated in some sort of nonlinear process of frequency conversion of the original optical packet (some examples of such conversion includes second harmonic of the frequency, or higher harmonic of the optical packet; parametric conversion of the pulse in the presence of other radiation, etc). While this implementation appears to be more complex compared to the implementations, described earlier, it will offer some practical advantages, as shown below. We will use an example usage of second harmonic process.

In the previously proposed methods, both header and payload of the optical packet were able to affect the propagation properties of the medium, as they were of the same frequency. While special measures can be taken to reduce this unwanted influence, it can not be eliminated completely.

As we will show below, use of second harmonic may allow to control the direction of the optical packet propagation using information from header of the packet only. This is due to the fact that it is possible to form and process optical packet in such a way that second harmonic signal will be generated by the packet's header only

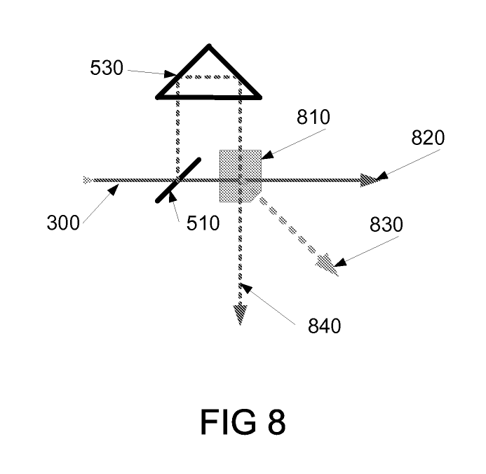

We will describe below one of the potential methods to implement switching of the packet using second harmonic of its header. In this method header of the optical packet 300 is used to generate second harmonic of the original optical frequency, so that the radiation at this doubled frequency could be used to control direction of propagation of the optical packet. The first step of this process, see FIG. 8, is to generate second harmonic signal based on the information in the header of the optical packet 300. To achieve this, the original optical packet is split in two, and one packet 820 is delayed relative to another 840. The delay 510, 530 is selected so that only pulses from the header do overlap in time, while the train of pulses from payload do not overlap (this could be done by appropriately choosing header's structure). Then these two packets are mixed in the non-linear crystal 810, where second harmonic radiation 830 is generated. The properties of the nonlinear crystal are selected so that the second harmonic signal is generated only when radiation from both packets is present (while on the FIG. 8 straight and delayed packets are shown as intersecting each other, this is done for the purpose of ease of demonstration. It is absolutely possible to achieve the same result when both signals propagate along the same path in the nonlinear crystal. In this case, for example, the requirement that second harmonic is generated only when both signal are present could be implemented by selecting the properties of the nonlinear crystal in such a way, that each signal should be of mutually orthogonal polarization, and only when both polarizations are present then the second harmonic signal is generated).

Second harmonic signal is used to control the direction of the propagation of the optical packet. In it's simplest form, when header is coded to have only two values “0” and “1”, there will be two paths for the packet, each path will correspond either to “0” or “1” of the header. When the header is set to “1”, then we will have an output second harmonic signal. This signal will be used to modify the electromagnetic properties of the media, so that the optical packet will propagate differently compared to the situation when there is no second harmonic signal (header is set to “0”). This second harmonic signal could be implemented for all methods discussed previously.

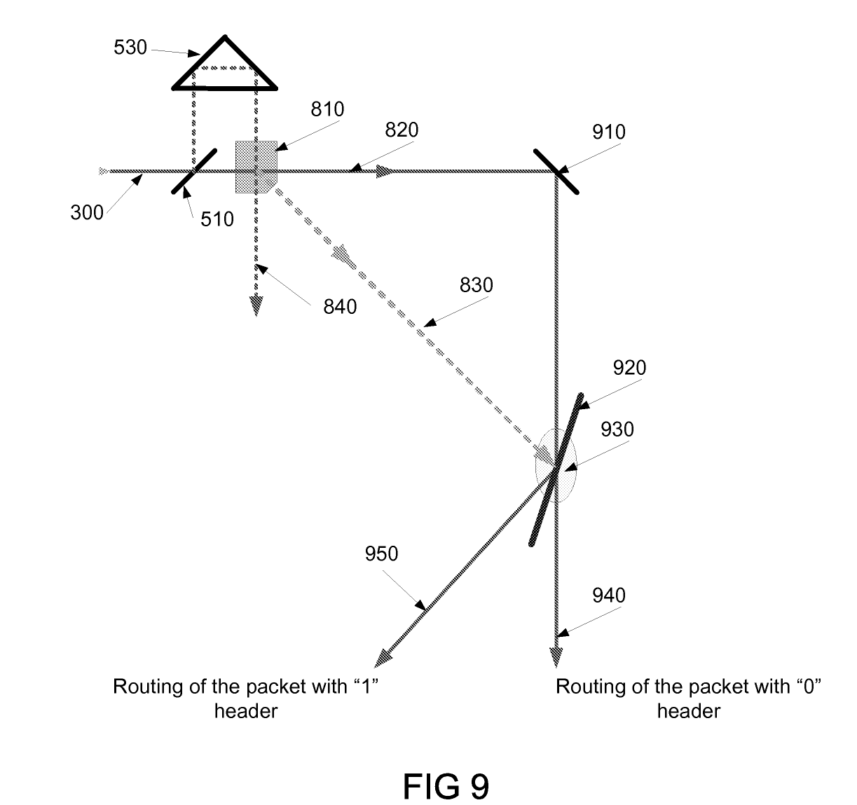

One additional possible method to implement all-optical switching using non-linear transformed frequency of the optical packet is to use it for the process of creation of the plasma mirror 930, as shown on FIG. 9 (we will use an example usage of second harmonic process).

In this process the second harmonic radiation 830 is causing the increase of the surface density of free electrons beyond critical point 920, so that incoming optical packet will be reflected 950, while in the absence of the plasma mirror the same pulse will propagate through this surface without reflection 940 (see FIG. 9).

Utilization of the second harmonic makes the use of the plasma mirror effect possible, as optical properties of the media at the second harmonic frequency is very different from the one at first harmonic. It will be significantly more difficult to use effect of plasma mirror when both controlling packet and the routed packet to be of the same frequency.

While this invention has been described with specific embodiments thereof, it is evident that many alternatives, modifications, and variations will be apparent to those skilled in the art. Accordingly, the preferred embodiments of the invention as set forth herein are intended to be illustrative, not limiting. Various changes may be made without departing from the spirit and scope of the invention.

What is claimed is:

1. An all optical switch that performs routing of optical pulses based on the information encoded in to the packet header without converting these pulses into electrical form.

1. An all optical switch that performs routing of optical pulses based on the information encoded in to the packet header without converting these pulses into electrical form.

2. An all optical switch according to claim 1, wherein optical switching is performed according to the structure of the packet of the optical pulse.

3. An all optical switch according to claim 1, wherein optical switching is performed according to the intensity of the packet of the optical pulse.

4. An all optical switch according to claim 1, wherein optical switching is performed according to the duration of the packet of the optical pulse.

5. An all optical switch according to claim 1, wherein optical switching is performed when the propagation of the optical pulse is affected by the electronic density wave, created by the pulse's header.

6. An all optical switch according to claim 5, wherein optical switching is performed when the propagation of the optical pulse is affected by the electronic density wave, created by the non-linear transformation of the frequency of pulse's header.

7. An all optical switch according to claim 1, wherein optical switching is performed when the propagation of the optical pulse is affected by plasma mirror, created by the non-linear transformation of the frequency of pulse's header.
